(19) United States
(12) Patent Application Publication
(10) Pub. No.: US 2005/0209901 A1
(43) Pub. Date: Sep. 22, 2005

(54) System and method for engineering project tracking

(76) Inventors: Scott Miller, Peoria, IL (US); James Richmond, Peoria, IL (US)

Correspondence Address: Clifford Kraft, 320 Robin Hill Dr., Naperville, IL, 60540, US

(21) Appl. No.: 11/081,793

(22) Filed: Mar. 16, 2005

Related U.S. Application Data
(60) Provisional application No. 60/521,245, filed on Mar. 18, 2004.
(60) Provisional application No. 60/521,245, filed on Mar. 18, 2004.

(51) Int. Cl. G06F 17/60

(52) U.S. Cl. 705/8

(57) ABSTRACT

A system and method for engineering project tracking where engineers can enter data for each task of each project they worked on for many different clients. Each type of task can have a work code. The system manages engineering projects for a large number of projects and a large number of clients. The system can keep track of each employees time and all time spent on a project. The system can provide data for payrolls, detailed invoicing and project history management. Alarms can be posted when a project is running low on allocated time or funding.

This application is related to, and claims priority from, U.S. provisional patent application No. 60/521,245 filed Mar. 18, 2004. Application 60/521,245 is hereby incorporated by reference.

### BACKGROUND

1. Field of the Invention

The present invention relates generally to the field of project tracking and more particularly to a system and method that tracks, controls and relates costs on engineering projects.

2. Description of the Problem

It is known in the art to provide computer software to track engineering projects. Some of these programs provide critical path analysis and resource management; others provide cost analysis, while still others produce progress reports or cost totals. None, however can manage a large number of projects for a large number of clients simultaneously.

Large engineering houses and consultants may have numerous ongoing projects for different clients at any given time. It is essential to manage time and costs and to bill the client for time spent on the project. With many employees, many projects and many clients, this process can become very difficult to control. It is usually inadequate to simply send a total invoice for services rendered to a client at the end of the month; rather, the client generally wants a breakdown of how the money was spent on a project by project basis, including how much time each engineer or technician spent on that particular project, what type of work were they doing, and the amount spent by that person doing that work. This can become particularly difficult when a certain employee can perform different tasks relating to a project that are billed at different rates. A client would also like to know that a project is running out of allocated money before that money is totally spent. In order to provide this type of information for management both inside the engineering firm and for the clients, it is necessary to capture it, organize it and present it.

It would be advantageous to have an engineering project management system and method that could track engineering projects for a large engineering or consulting operation, change controls on these projects while monitoring in real-time the time and costs as well as optionally include an invoicing system, reporting system, interface with the internet, control payroll, control billing and/or produce profitability reports.

### SUMMARY OF THE INVENTION

The present invention relates to engineering project tracking and control. Various embodiments of the invention allow access to a central program and database by users using the internet or by any other means. Access to the system by the internet is optional; any type of access known in the computer arts is within the scope of the present invention. Access into the system from the internet means that a user can be located anywhere in the world where there is internet service. A particular project can be accessed by different individuals with different levels of access. The present invention can control access by user and only allow a user to read or enter information which that user is authorized to. This means that many different people working on the same project can have individual access to their own unique part of the project without being able to view parts of the project outside their authorization or to enter data or make changes they are not allowed to. Also, various employees can enter a predetermined work code to show what type of work they were doing for that entry with the work code automatically determining the billing rate for that work. It is within the scope of the present invention to bill different clients different amounts for the same work code.

The present invention can build metrics and assist in managing engineering projects in the environment of a large engineering organization where there are numerous clients, numerous projects for a particular client, and numerous people working on the various projects in different capacities. A typical embodiment of the invention can handle entry and reporting from multiple users working on many different projects. The metrics built can lead to improvements in employee productivity, determining process failures or inadequacies, lessons learned from past projects and/or project time to market measures. This functionality provides management several different resources comparing productivity, accuracy and quality, thus allowing better utilization of resources as well as provide invoicing, payroll and cost reporting.

The present invention can allow users to display all active projects by client. Data can be entered and updated by project or client, and various warnings can be displayed for particular projects—for example that the project is 75% or 90% spent or that the project is overspent. Reports of progress, spending and resource allocation can be produced for any project.

A feature of some embodiments of the invention allows particular users to have custom screens which are modeled after screens used by their own company. This could be applicable to clients entering data. This specific screen or GUI presentation can allow a user to work in the same environment he or she is used to working in while entering or viewing data.

### DESCRIPTION OF THE DRAWINGS

FIG. 1 is a block diagram overview of an embodiment of the present invention.

FIG. 2 is a screen depiction of a project status request screen.

FIG. 3 is a screen depiction of a display of all projects for a particular client.

FIG. 4 is a screen depiction of a time entry by an employee for a particular project.

Several illustrations and figures have been presented to better aid in the understanding of the present invention. The scope of the present invention is not limited to the figures.

### DESCRIPTION OF THE INVENTION

The present invention relates to a system and method for engineering project tracking. The software of the present invention represents an internal process for an engineering firm to track engineering projects, change control on these projects as well as time and cost. The system of the invention can be online on the internet. Information can generally be stored by individual user profile and secured with ID and passwords. The information can be dynamically updated in real-time for accurate, up-to-date information reporting.

The present invention provides the ability to track information in many different ways. The system can generally receive entry and reporting from multiple users from anywhere that internet access is possible. Access to the system allows employees and clients to access information in a controlled way. Exactly what information is available to a particular user (or what can be entered) is controlled by their logon and password. This allows the system to produce customized reports for specific individuals. The system optionally allows graphical interfaces that are modeled to look and feel like the interfaces used in a client's particular company. The system can control who can enter data, what data they can enter, how they can enter it, and where they can enter it as well as controlling who has access to what data.

The system of the present invention can take information from the controlled database and build metrics that assist both the engineering firm and the clients improve the process. These metrics can be in the form of employee productivity, determining process failures or inadequacies, lessons learned from past projects or project time to market, as well as many other possible metrics. This functionality allows the engineering firm to manage several different resources comparing productivity, accuracy and quality to allow better utilization of resources.

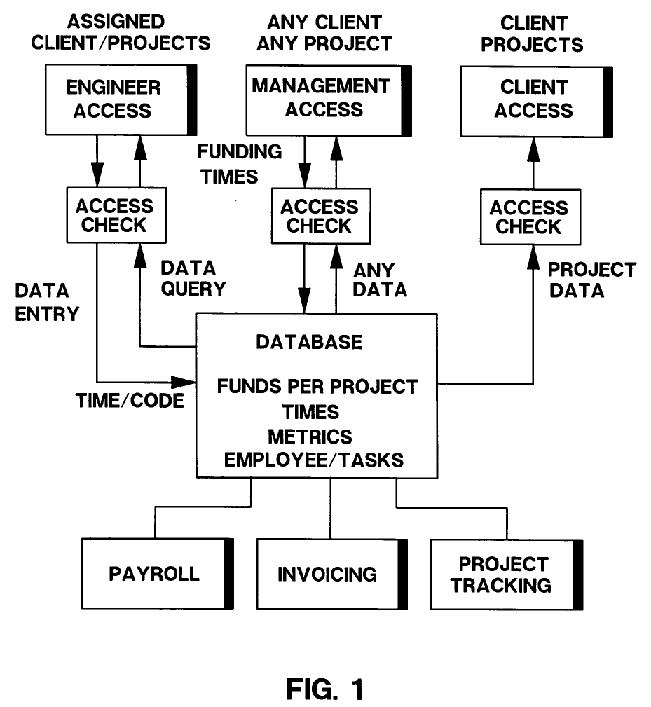

FIG. 1 shows an overview of an embodiment of the present invention. At the top of FIG. 1 are shown blocks representing Engineer Access, Management Access and Client Access. Engineers and management may be allowed to enter particular data into the system as well as retrieve it. Normally, clients cannot enter data; however, in some cases, it is necessary or desirable to allow a client to enter data. In all cases, the system performs access checks to determine who is requesting data or attempting to enter or change it. A particular individual can be identified by ID and a password or by any other identification method. An engineer, for example may have access to a certain set of projects, but not others. Management generally has access to all projects. A client may only have access to projects belonging to it, or to a subset of these.

In the center of FIG. 1 is shown a database. This database is generally maintained on a computer and can contain information for all projects and all clients. This database is normally protected and backed up by methods known in the art. In particular, the database can contain funds allocated and spent for each project, projected and used times, particular metrics and particular employee tasks to be performed or that have been performed. The database is generally accessible on a client or project basis. The system of the present invention generally includes the following types of databases: client databases that list the client, contact person, phone and fax numbers, email, etc.; employee databases that lists all employee information such as status, name, SS#, pay rate and other information; project databases that list all projects and the details associated with these projects such as purchase order numbers, billing charge codes, purchase order amount and type of billing; activity codes which list all activities associated with an hour worked. Each different activity code can have particular specific dollar charges associated with it. These billable charges may vary from project to project or client to client.

At the bottom of FIG. 1 are several examples of metrics, reports and other outputs that the system of the present invention can produce. One example is a payroll. Since each engineer's (technician's or other employee's) time has been recorded in the database, the entire firm can be paid correctly (including overtime, etc.). Because all work done that month (or week or other period) has been recorded in the database including the time spent, a client can be correctly invoiced. In addition, a client invoice can be broken down by project and even task if desired. The present invention allows the creation of custom invoices that suit the particular needs of various clients. Different clients may receive different types of invoices depending on what they need.

A very important feature of the present invention is the ability to track projects in real-time. As seen in FIG. 1, project tracking can be produced for any project in the database. Project tracking can provide both the firm's management and the client a real-time picture of the status of a project including the amount of time used or remaining and the amount of funding allocated and spent. In addition, the project tracking feature of the present invention can provide real-time alarms or signals if a particular project has reached a predetermined percentage of funding spent or time spent (or is out or time or out of money).

The system of the present invention optionally includes a series of activity codes. Generally a client is invoiced, not by who did the work, but by what type of work was done. For example, analysis may be billed at a quantum of $75 while detailing may be charted at $45. This feature of the invention results in fairer billing since the client is being paid for the type of work being done as well as how long it took. When an engineer makes an entry concerning work done, an activity code can be also entered. The system then can compute billing for that time based on the activity code and the client. It is within the scope of the present invention to bill different clients different amounts for the same activity code. This might be done in a case where a preferred client is given lower (or otherwise different) rates. A representative set of activity codes for a particular client are included in Appendix A.

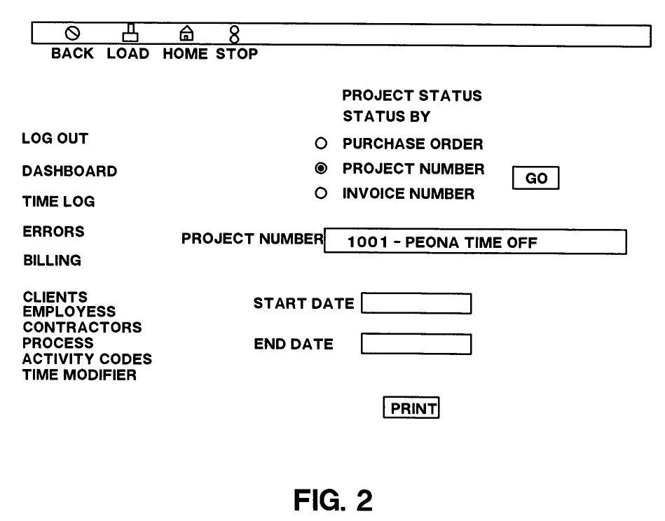

FIG. 2 shows a screen depiction of an entry by a particular engineer showing time off for that engineer on project number 1001. This type of screen can be used to gain access to a project after a particular person has signed on.

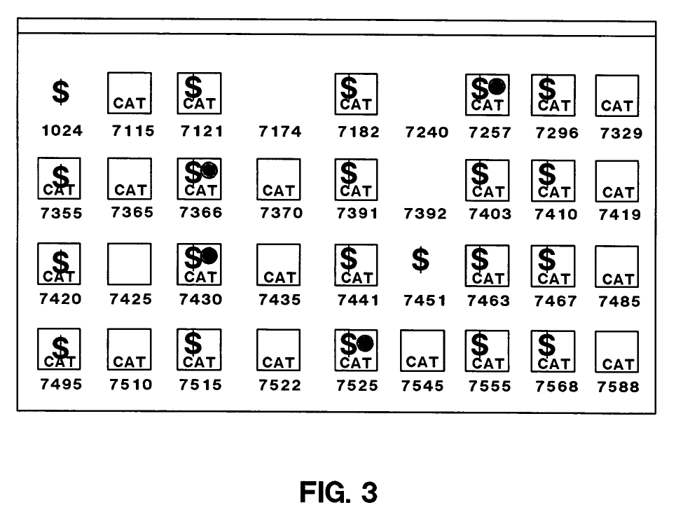

FIG. 3 shows a rectangular screen representation of every project that belongs to a particular client “Cat”. This type of representation can be called a “Dashboard”. The dashboard screen may be viewed on any user's computer or hung in an office for employees to see. Generally this type of display uses a customer's unique icon with project numbers shown below the icons. On the face of each icon, there may be symbols superimposed such as dollar signs $ and other symbols. For example, a solid yellow flashing dollar sign could mean that the allocated purchase order dollars have reached a point of 75% to 95% of the total purchase order (or any other percentages). This could indicate to the appropriate project manager that either the project needs to be completed soon, or additional funds will have to be requested from the client. Other symbols such as a red dollar sign could mean that all the money for a project has been spent. Many other types of symbols and indicators can be placed on a dashboard type of screen to indicate items of interest. In particular clocks showing the amount of time remaining or that time has been used up can be used. Any type of symbol with any meaning, activity or color is within the scope of the present invention.

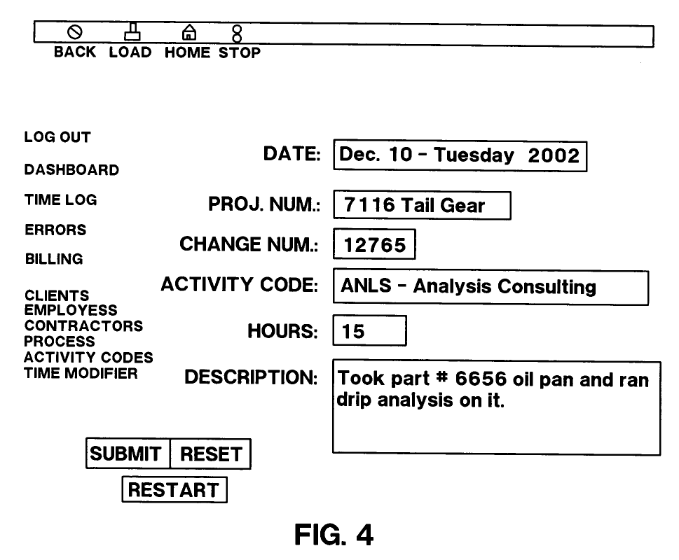

FIG. 4 shows an example screen where an engineer has made a time entry. On this screen, the project number is 7116, and the activity code for the time being entered is ANLS standing for analysis. The engineer is entering 15 hours for the task of running a drip analysis on an oil pan. Numerous different screens are within the scope of the present invention. Appendix B shows a printout of a history of a particular project.

Generally every hour that is worked on a project is logged by activity code by project along with a detailed description of the task that was completed and the number of hours being entered as shown in FIG. 4. Project information can be updated every day or more often as employees enter their time on various tasks. Normally a client may log on to the system and sort this activity on their projects by activity code, by invoice, by purchase order or by other means to see exactly the detail they have been receiving on every job.

The system of the present invention can contain a time entry module that allows each employee to log every hour that is worked and charge it to the appropriate billable or non-billable project number. In addition to entering time, employees can enter significant events such as changes of scope and work completion dates such as shown in FIG. 2. This information can be used at least two ways: it can be downloaded into a payroll system to produce periodic payroll checks and serve as a system of payroll timecards, and the information may be used to populate the project status reporting for a particular client.

The system of the present invention can contain a project module that is normally used primarily by the client. This module can be the client's portal into the details of their projects. The client can log onto the system and search for particular projects by project number, purchase order number or other project identifiers. In general a client can check; the total billings to date for each project and the percentage complete; the total dollars billed broken down by activity or charge codes, or customer billing charge numbers; details of every hour spent and what tasks were performed for those hours including every employee that worked on that project; a summary of significant events related to the project such as start and end dates, dates and descriptions of changes of scope, dates certain activities were performed such as FMEAs and design reviews; and other relevant project information.

The system of the present invention can contain an invoicing module. This is generally a billing module that is driven by the time entry module. The invoicing module can summarize all time by client and project and can produce a customized invoice with appropriate information for each customer. The invoicing module can have a posting function that protects from double billing or from not billing and item.

A typical invoicing module of the present invention can allow for custom design for each separate client or for different divisions within a client's organization. For example, each client may require different information on their invoice. A client may have a 10 digit charge code that is required for each project. Other clients may have no particular charge codes. The system of the present invention can track input time by the particular client's charge code and automatically put that code on all of the client's invoices. In addition, the present invention has the ability to track billings by week, bi-monthly, monthly and by any other period. The system can customize invoices on a per-client basis. Appendix C shows a printed invoice.

The system of the present invention can have a reporting module. The reporting module is normally used by internal management. The reporting module can: provide payroll information such as a summary or details of hours worked by a particular employee; a purchase order summary that can summarize all existing client purchase orders; a charge number summary that can summarize charges by charge number; project status information that can summarize the details of each hour worked on a particular project; project activity which can detail the revenue, cost and profit by employee for each particular project; customer type summary which can summarize projects by customer type; employee profitability which can summarize the revenue, cost and profit by each employee; and many other reporting functions.

The system of the present invention is particularly concerned with security. Any security methods are within the scope of the present invention. For example, a unique password based on a user's specific Email address and computed IP address can be generated. This password can be automatically changed on a monthly or quarterly basis (or any other basis), and the user can be issued a new password by Email or other means. In addition, if a user enters the system from a computer that is different than the IP address upon which that user was originally set up on, the system can send Email to the system administrator for confirmation and to report a possible breach of security. In addition, the user can be contacted.

The system of the present invention generally controls what information each particular user of the system can access and what information that user can change, if any. This allows for customized screens, interfaces and reports for particular users that can be determined by their passwords or logon IDs. This allows the creation of interfaces that have the look and feel of a user's own company interface.

Appendix A shows a list of activity codes. Each activity code has a certain dollar rate associated with it. This can be different for different clients or for different projects.

Appendix B shows a printout of a project history.

Appendix C shows an invoice to a particular client using charge codes.

Several descriptions and examples have been presented to better aid in understanding of the present invention. One skilled in the art will realize that many changes and variations are possible. All such changes and variations are within the scope of the present invention.

[image]

[image]

[image]

1. An engineering management system for tracking activity and costs for a plurality of engineering projects comprising:
a means for an employee to enter time and activity data by project according to predetermined work codes;
a means for storing said time, activity and work code data for each project;
a means for organizing said time, activity and work code data for all employees entering data for that project or client so that project information becomes available on a project basis or client basis;
a means for invoicing a particular client based on said data wherein said invoicing displays time, activity and cost for a particular project over a particular time period;
a means for continuously tracking project costs based on said project information.

2. The system according to claim 1 further comprising reporting on a project basis cost percentages of total allocated costs for that project.

3. The system according to claim 2 further comprising causing a visible alarm when a particular project reaches a predetermined percentage of said total allocated costs.

4. The system according to claim 1 further comprising tracking employee's time on a project basis.

5. The system according to claim 4 further comprising producing a payroll based on tracking said employee's time.

6. The system according to claim 1 further comprising producing a project summary report for a client based on said project information concerning work done on a particular project.

7. A method of tracking engineering projects with multiple projects for multiple clients comprising the steps of:
entering into a database a task entry containing at least time spent and work code for a particular task belonging to a particular project;
storing a plurality of task entries in said database accessible by project and client;
producing a client invoice billing on a per-project basis, said invoice reporting amount billed according to work codes.

8. The method of claim 7 further comprising associating said task entry with a particular employee.

9. The method of claim 8 further comprising producing a payroll based on a plurality of task entries.

10. The method of claim 7 further comprising tracking a project using said task entries as well as funds allocated to said project.

11. The method of claim 10 further comprising reporting when said project has used a predetermined percentage of said allocated funds.

12. The method of claim 7 further comprising tracking a project using said task entries as well as total time allocated to said project.

13. The method of claim 12 further comprising reporting when said project has used a predetermined percentage of said allocated time.

14. A system for managing a engineering projects comprising:
a computer;
a computer entry terminal;
a printer;
a set of work codes;
a software program running on said computer which accepts a task entry from said terminal by a particular employee related to a particular project for a particular client, said task entry containing at least one of said work codes as well as a quantity of time spent performing work;
producing an invoice on said printer wherein said invoice contains a cost entry for said work code for said particular project for said particular client.

15. The system of claim 14 further comprising said software program providing said amount of time for said employee to a payroll program.

16. The system of claim 14 further comprising said software program producing management reports showing amounts of time for specific work codes related to said particular project.

17. The system of claim 14 further comprising entering from a terminal into said software program an amount of funding for said particular project.

18. The system of claim 17 further comprising said software program producing a warning when remaining funding equals a predetermined percentage of said funding.

19. The system of claim 14 wherein said terminal communicates with said computer via the internet.

20. The system of claim 14 wherein said software program reports an amount of time used for said particular project.
